(19) United States
(12) Patent Application Publication
(10) Pub. No.: US 2026/0021682 A1
(43) Pub. Date: Jan. 22, 2026

(54) FUSED KINETIC RECOVERY ROPE

(71) Applicant: Polaris Industries Inc., Medina, MN (US)

(72) Inventors: Jonathan M. Hetland, Lino Lakes, MN (US); John M. Nutter, Stacy, MN (US); Jeremiah T. Johnstun, Elk River, MN (US); Bradley Vollmer, Ham Lake, MN (US); Jack Damiano, St. Paul, MN (US); Daniel P. Strobach, Luck, WI (US)

(21) Appl. No.: 19/273,575

(22) Filed: Jul. 18, 2025

Related U.S. Application Data
(60) Provisional application No. 63/673,343, filed on Jul. 19, 2024.

(51) Int. Cl. B60D 1/18; D07B 1/02; D07B 1/14

(52) U.S. Cl. CPC B60D 1/18; D07B 1/02; D07B 1/145; D07B 2205/2046

(57) ABSTRACT

A kinetic recovery system for recovering a stuck UTV or ATV utilizing a recovery UTV or ATV. The kinetic recovery system comprising a kinetic recovery rope portion connected to a fuse portion. The fuse portion having an activation load limit less than the tensile strength of the kinetic recovery rope portion. The fuse portion on activation providing an extension of the length of the fuse portion at least equal to the elongation of the kinetic rope portion.

### BACKGROUND

This application claims the benefit of priority to U.S. Provisional Application Ser. No. 63/673,343, filed Jul. 19, 2024, the content of which is herein incorporated by reference in its entirety.

### BACKGROUND

Recreational and utility vehicles are used in various terrains and environments. Accordingly, it is not uncommon for such vehicles to become stuck, for example in the mud, where the vehicle is unable to traverse an obstacle under its own power or without assistance. Often another vehicle is utilized to pull out the stuck vehicle.

### SUMMARY

Kinetic recovery ropes can be utilized to recover a stuck vehicles. The kinetic recovery rope can extend to a pull or recovery vehicle. Such kinetic recovery ropes utilize the stored kinetic energy and elasticity of the kinetic recovery rope to provide, in many cases, a generally smooth and controlled recovery. Selected kinetic recovery ropes can allow significant stretching under loading, often up to or approximately 20% of their unstretched length with the stretched rope storing significant kinetic energy. The elasticity of the kinetic recovery ropes can absorb shock where the tow vehicle has excess speed in taking up the slack in the kinetic recovery rope. Such elasticity can prevent overloading the frames of the stuck vehicle and the recovery vehicle.

Generally, utility task vehicles (UTV) and all-terrain vehicles (ATV) can have connection points with load ratings that when exceeded can cause damage to the frames. Such load ratings are generally understood to be about 3 to 4 times the vehicle weight. Where a kinetic recovery rope is oversized from optimal sizing and is utilized to recover a stuck UTV or ATV, the lack of elasticity of such a kinetic recovery rope can more readily cause damage to the vehicles during the recovery operation.

Generally, where a stuck vehicle is not released from the stuck position, and the recovery rope has a tensile strength, that can be a breaking point, with a load level that exceeds a load limit of a recovery connection point of the stuck vehicle or the recovery vehicle, damage to frame of either or both vehicles can occur before breakage of the rope. The operators of the stuck vehicle and recovery vehicle, at times, can have no overt, if any, indication that such damage can occur or that the recovery point load limit is being approached. Where the breaking point of the kinetic recovery rope is exceeded, the kinetic recovery rope can break into two pieces, releasing the kinetic energy stored in the kinetic rope by the rope into two or more pieces, with at least one piece possibly snapping back toward at least one of the two vehicles which can be damaging and hazardous. This can more readily happen where the kinetic recovery rope is undersized from the optimal sizing. Non-optimally sized ropes can be more easily overextended, that is elongated, and result in breakage.

The present disclosure describes a fused kinetic recovery system that can be used with vehicles including, but not limited to, all-terrain vehicles (ATV) and utility task vehicles (UTV) having a frame and a tow or vehicle recovery mounting point with associated loading limits. In embodiments, fusing of the kinetic recovery ropes, can provide a yielding of the kinetic recovery system, that is a controlled elongation at a predetermined fuse activation load, after the expected stretching of the kinetic recovery rope due to the recovery efforts, rather than damage to the vehicles and/or the release of kinetic energy by an abrupt rope breakage with the loose ends snapping back. The yielding can dissipate the stored kinetic energy in the stretched kinetic recovery rope. In embodiments, the yielding can reduce the abruptness of the release of the recovery vehicle.

In embodiments, a kinetic recovery system can include a kinetic recovery rope portion and a fuse portion or fuse. In embodiments, the kinetic recovery system can include a pair of kinetic recovery rope segments, each segment having a distal connection end for connection to a connection point on the stuck vehicle and the recovery vehicle, such as a woven or spliced-in loop or a soft shackle, and having an opposite end having a connection to or extending into the fuse portion. That is, the fusing portion being connected in between the pair of kinetic recovery rope segments. In embodiments, the kinetic rope segments each having a breaking load limit, and the fusing portion selected to have a fusing activation load point below the breaking load limit of the kinetic rope segment.

In embodiments, the fuses described herein can be configured to activate at a set force load, the set force load being lower than the breaking load on the rope, such that when a fuse is activated, it defuses the stretched rope and dissipates the stored kinetic energy without allowing the ends of the rope to recoil.

In some embodiments, a kinetic recovery system for repositioning a stuck vehicle includes a first rope portion, a second rope portion, and a breakable linkage with delayed or no separation. The first rope portion can be configured to attach to a pull vehicle. The second rope portion can be configured to attach to the stuck vehicle. The first and second rope portions can be formed of the same material. The breakable linkage can be affixed between the first and second rope portions. The breakable linkage can have a lower tensile strength than the first and section rope portions. In embodiments, a visual indicator can be provided where the fusing can be activated.

In embodiments, a recovery system attachable between a pull vehicle and a stuck vehicle, UTV's and/or ATV's, the recovery system includes a kinetic recovery rope, and a fuse positioned in line with the kinetic recovery rope. The kinetic recovery rope includes synthetic fibers and having a stretch length under a designated load limit of the kinetic rope providing a stretch range of about 15% to 25% of a resting or unloaded length. The fuse can be configured or selected with an activation within the stretch range, before a breaking limit of the kinetic rope can be reached. In embodiments, the fuse actuates at a load that equates to about a 20% stretch of the kinetic rope, or about 25% to about 35%. In embodiments, the fuse actuates at a load that equates to a range of about 15 to 20% stretch of the kinetic rope. In embodiments, the fuse providing a visual indication of activation to the recovery vehicle operator and/or the stuck vehicle operator.

In some embodiments, a metal free recovery system attachable between a pull vehicle and a stuck vehicle includes a fuse in line with a kinetic recovery rope. The fuse can be configured to activate under a predetermined force and provide an indication of activation to a pull vehicle and/or stuck vehicle operator.

A feature and advantage of embodiments can be an overload protection system that protects a vehicle from damage, including particularly damage to the framework. A feature and advantage of embodiments can be preventing recoil from the breaking of an overloaded recovery rope. A feature and advantage of embodiments can be providing notification to an operator of an overload scenario before the vehicle frame, chassis, suspension, or other components suffer significant damage and/or a hazardous situation can be created. A feature and advantage of embodiments can be reducing overstressing and potential fatigue on the vehicle frame components at recovery connection points.

In some embodiments a kinetic recovery rope can include a fuse wherein upon actuation the fuse provides an extended release with an elongation allowing stretched portions of the kinetic recovery rope to retract toward an unstretched initial length after actuation when a load limit can be reached. A feature and advantage of embodiments can be that such extended release with the elongation provides an indication to the operators of the stuck vehicle and/or recovery vehicle that the fused load limit of the kinetic recovery rope has been exceeded and that the fuse has been activated. Such indication is, at least in part, visual, allowing the recovery vehicle to cease the pulling of the stuck vehicle.

A feature and advantage of embodiments can be a fusing segment, or portion can be added to an existing kinetic recovery rope that has a load limit, with the fusing segment having a fuse point of the fusing component set to be less than the tensile strength of the existing kinetic recovery rope. The fusing can provide protection in instances where the kinetic recovery rope can be not optimally sized for the stuck and/or recovery vehicle.

In embodiments, a fused kinetic recovery system has one or more kinetic recovery rope segments, one or more kinetic recovery fuse portions, one or more vehicle connectors, such as soft shackles, connected to or connectable to the one or more kinetic recovery rope segments and/or kinetic recovery fuse segment, packaging, and instructions for use.

In embodiments, a fuse for a kinetic recovery rope or system, has an indicator means for visually indicating actuation of the fuse. In embodiments, the indicator means can be a flag released upon activation. Such a flag, in embodiments can have indicia and/or coloration that provides pronounced indication of the activation, for example a day-glow coloration. In embodiments the flag can provide directions and/or warnings regarding the status/condition of the kinetic recovery rope. In embodiments, the indicator means can be a smoke generator such as a powder release, the powder can have coloration.

In embodiments, a fuse for a kinetic recovery rope has a first inactivated length, a fully activated connected length, and a plurality of intermediate lengths in between the inactivated length and the fully activated length. In embodiments, the difference between the fully activated connected length and the inactivated length can be equal to or greater than the length of elongation of the recovery rope portion at the fuse activation load level. This release allows the operator of the tow vehicle time to stop the pulling of the vehicle.

Kinetic recovery ropes can be sized to the weight of the vehicles being utilized and can be made from braided Nylon fibers. UTVs and ATVs are often designed to have recovery attachment points for utilization when the vehicle can be stuck, and another vehicle can be being utilized to recover the vehicle. Such recovery points have load limits where the vehicle frame can be damaged if loading on recovery point exceeds the load limits. Although such load limits are not typically published, conventional thinking can be that such load limits can be approximately 3 to 4 times the weight of the UTV and/or ATV and other vehicles suitable for off-road use. The braided nylon can have a diameter of approximately ½ inch or less. Some manufacturers of recovery ropes recommend that recovery ropes have a load capacity, that can be a breaking point, also of about 3 to 4 times the weight of the subject vehicle. Braided nylon ropes generally elongate up to 30 to 35% at their breaking points. Providing loading on kinetic recovery ropes such that elongation can be about 20% or less has proven to be effective for vehicle recovery. The providing of fusing that limits such loading to an elongation of the kinetic recovery rope to 20% or less, and that precludes uncontrolled release of the kinetic energy if there can be a breakage, would be well received by the industry and consuming public. In embodiments, fusing can be provided that can be scaled to the weight (unloaded, empty) of an off-road UTV or ATV vehicle, the activation load level being selected to be within the range of approximately 100% to approximately 200% of the vehicle weight. In embodiments, fusing can be provided that can be selected and scaled to the weight (unloaded, empty) of an off-road UTV or ATV vehicle, the activation load level being selected to be within the range of 150% to 300% of the vehicle weight. In embodiments, fusing can be provided that can be scaled to the weight (unloaded, empty) of an off-road UTV or ATV vehicle, the activation load level being selected to be within the range of approximately 200% to approximately 350% of the vehicle weight.

In embodiments, fusing can be selected for or provided for a UTV or ATV, that has a fuse activation loading level that can be at least 30% less than the tensile strength of kinetic recovery rope to which it can be attached, and where a kinetic recovery rope can be selected to have a tensile strength of approximately 3 to approximately 4 times the weight of the UTV or ATV. In embodiments, fusing can be selected for or provided for a UTV or ATV, that has a fuse activation loading level that can be at least 45% less than the tensile strength of kinetic recovery rope to which it can be attached, and where a kinetic recovery rope can be selected to have a tensile strength of approximately 2.5 to approximately 4.5 times the weight of the UTV or ATV. In embodiments, fusing for an off-road vehicle can be selected for a kinetic recovery rope portion where the fuse activation level corelates to a load level of the kinetic recovery rope portion that has at least 30% less elongation than the total kinetic recovery rope portion elongation at the breaking point of the kinetic recovery rope portion. In embodiments, fusing for an off-road vehicle can be selected for a kinetic recovery rope portion where the fuse activation level corelates to a load level of the kinetic recovery rope portion that has at least 20% less elongation than the total kinetic recovery rope portion elongation at the breaking point of the kinetic recovery rope portion.

In embodiments, a UTV or ATV can be provided with directions identifying an appropriate sizing of a kinetic recovery rope and fusing for same. For example, on a UTV that weighs approximately 1500 lbs., a nylon rope with a working strength of about 4500 lbs. can be suitable and a fuse or fuse portion with an activation load level in the range of 2500 to 4000 lbs. can be suitable, the directions indicating such.

In embodiments, a kinetic recovery system for recovery of a stuck off-road vehicle, the kinetic recovery system connectable to the stuck off-road vehicle and to a recovery vehicle, the kinetic recovery system having a first kinetic rope portion having working loading with an elongation of from about 10 to about 20% of the unloaded kinetic rope portion, the first kinetic rope portion having a breaking load limit at an elongation in the range of about 25% to about to about 35%; a fuse portion having an inactivated length and a fully activated connected length, the fuse portion having an activation load limit less than the breaking load limit of the first kinetic rope portion.

In embodiments, a fuse portion for attachment to a kinetic recovery rope, the fuse portion can include the fuse portion having an elongate fuse element that can be arranged in an overlapping or bundled arrangement, with the arrangement secured together by a clamp, adhesive, potting, stitching, and/or an enclosure.

In embodiments, a method of protecting off-road vehicles involved in a recovery operation where a first off-road vehicle can be in a stuck position and a second off-road vehicle can be utilized to pull the first vehicle out of the stuck position with a kinetic recovery rope, the method including assessing the first vehicle frame load limits at the recovery attachment points of the vehicles and selecting a fuse portion with a kinetic recovery rope, the fuse portion having a activation load limit below the vehicle frame load limits at the recovery attachment points.

In embodiments, a kinetic recovery system comprising a kinetic rope portion formed of braided nylon recovery rope portion connected to a fuse portion, wherein the fuse portion under tensile loading have a pair of overlapping fuse elements subjected to shear loading, and wherein the fuse portion has an activation load level that correlates to when the overlapping fuse elements slip in shear with respect to one another.

### BRIEF DESCRIPTION OF THE DRAWINGS

The disclosure can be understood in consideration of the following detailed description of various embodiments in connection with the accompanying drawings.

FIG. 1 is perspective view of a kinetic recovery system attached to a pull vehicle and a stuck vehicle.

FIGS. 2A-2D are schematic conceptual views of kinetic recovery systems.

FIGS. 3A-3C illustrate a pictorial illustration of the PRIOR ART use of kinetic recovery ropes.

FIGS. 3D to 3G are pictorial views of UTV's utilizing a kinetic recovery system in accord with embodiments.

FIG. 4A is a side view of a kinetic recovery system.

FIG. 4B is a side view of the kinetic recovery system of FIG. 4A with a fuse portion activated.

FIG. 4C is a side view of the kinetic recovery system of FIG. 4A with the fuse element segments separated.

FIG. 5 is a side view of a kinetic recovery system.

FIG. 6A is a side view of an embodiment of a kinetic recovery system.

FIG. 6B is a side view of the kinetic recovery system of FIG. 6A with a portion of a fuse portion enclosure removed illustrating the overlapping fuse rope.

FIG. 6C is a side view of the kinetic recovery system of FIG. 6A with the fuse portion activated releasing a visual indicator of the activation.

FIG. 6D is a side view of the kinetic recovery system of FIG. 6A with the fuse rope segments separated.

FIG. 7A is a side view of an embodiment of a kinetic recovery system with a fusing portion having an expandable casing or enclosure.

FIG. 7B is a side view of the kinetic recovery system of FIG. 7A with the enclosure cut away revealing overlapping fuse rope.

FIG. 7C is a side view of the kinetic recovery system of FIG. 7A with the expandable enclosure expanded.

FIG. 7D is a side view of the kinetic recovery system of FIG. 7A with the expandable enclosure cut away illustrating the fuse elements with end stops to retain the fuse elements connected to the expandable enclosure after activation.

FIG. 8A is a side view of an embodiment of a kinetic recovery system with a fuse portion having internal fuse element and a coiled retention cord.

FIG. 8B is a side view of the kinetic recovery system of FIG. 8A with the fuse portion activated with the breaking of the inner fuse element and the coiled retention line extending.

FIG. 8C is a side view of the kinetic recovery system of FIG. 8A with the secondary fuse element shown fractured into two secondary fuse element pieces.

FIG. 9A is a side view of an embodiment of a fuse portion suitable for a kinetic recovery system utilizing straps as a fuse element.

FIG. 9B is a side view of the fuse portion of FIG. 9A with a covering over the fuse elements.

FIG. 9C is a perspective view of the fuse portion of FIG. 9A illustrating fuse elements configured as straps, the fuse elements constrained by stitching.

FIG. 9D is a perspective view of the fuse portion of FIG. 9A activated with the fuse elements partially separated.

FIG. 9E is a perspective view of the fuse portion of FIG. 9A with the fuse elements separated after activation.

FIG. 9F is a perspective view of the fuse portion of FIG. 9A with the fuse elements still attached after maximum elongation of the fuse portion.

FIG. 10 is a Stress Strain graph illustrating the delayed separation of fuse elements of a fuse portion of a kinetic recovery system.

FIG. 11 is a Stress Strain graph illustrating the undelayed separation of fuse elements of a fuse portion of a kinetic recovery system but with the fuse elements connected by a retention element.

FIG. 12 is a kinetic recovery system kit with instructions and alternate fuse portions.

FIG. 13 is a Prior Art loop of a braided nylon recovery rope.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations, and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

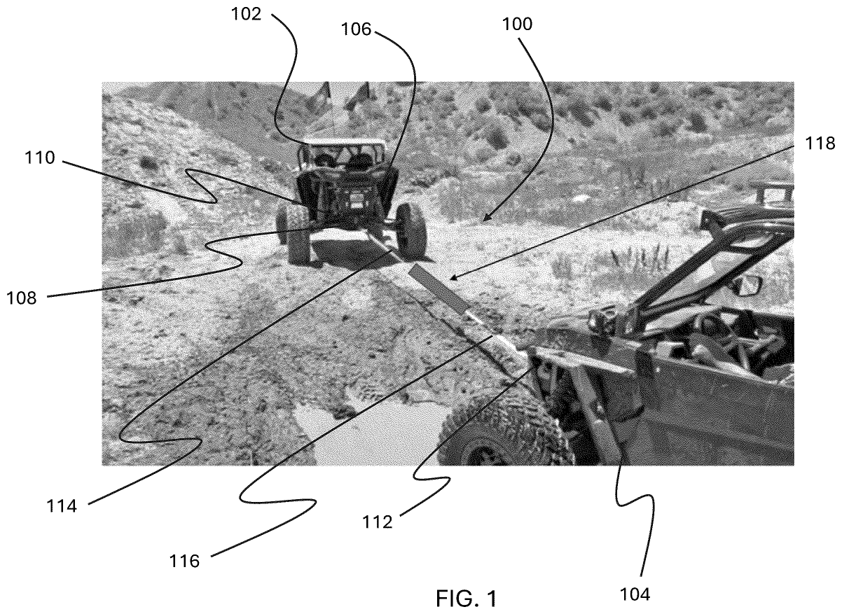

Referring to FIG. 1, a kinetic recovery system 100 is illustrated affixed between a pull or recovery vehicle 102 and a stuck vehicle 104. Vehicles 102, 104 can be off-road vehicles such as ATVs, UTV's with side-by-side seating or straddle seating. Such off-road vehicles 102, 104 can have a wide range of net weights (unloaded, empty). Straddle seat ATV's often weigh between 400 and 1000 lbs. UTVs and other single side-by-sides often weigh between 1000 and 2500 pounds. Quad seating side by sides can weigh from 1600 to 3500 lbs. Such off-road vehicles have a framework 106 with recovery attachment points 108 in rear 110 and front 112 portions of the framework 106 for tow ropes or the like. Although similar vehicles are illustrated, of course the pull off-road vehicle 102 and stuck off-road vehicle 104 can be different. For example, pull off-road vehicle 102 can be a UTV and stuck off-road vehicle 104 can be an ATV.

As shown, a first portion 114 of the kinetic recovery system 100 can be affixed to an attachment point 108 at the rear 110 of the pull vehicle 102 and a second portion 116 of the kinetic recovery system can be affixed to an attachment point 108 at the front 112 of the stuck vehicle 102. Stuck vehicle 104 is shown in a mud pit, however, there are many obstacles that can cause a vehicle to lose traction such as sand, loose gravel, snow, or the like, where the vehicle can be unable to move without assistance. Vehicles can also become stuck, for example, in rocks, logs, or the like, similarly requiring assistance. The kinetic recovery system 100 further includes a fuse portion 118, such as a breakable linkage disposed between the first and second kinetic rope portions 114, 116.

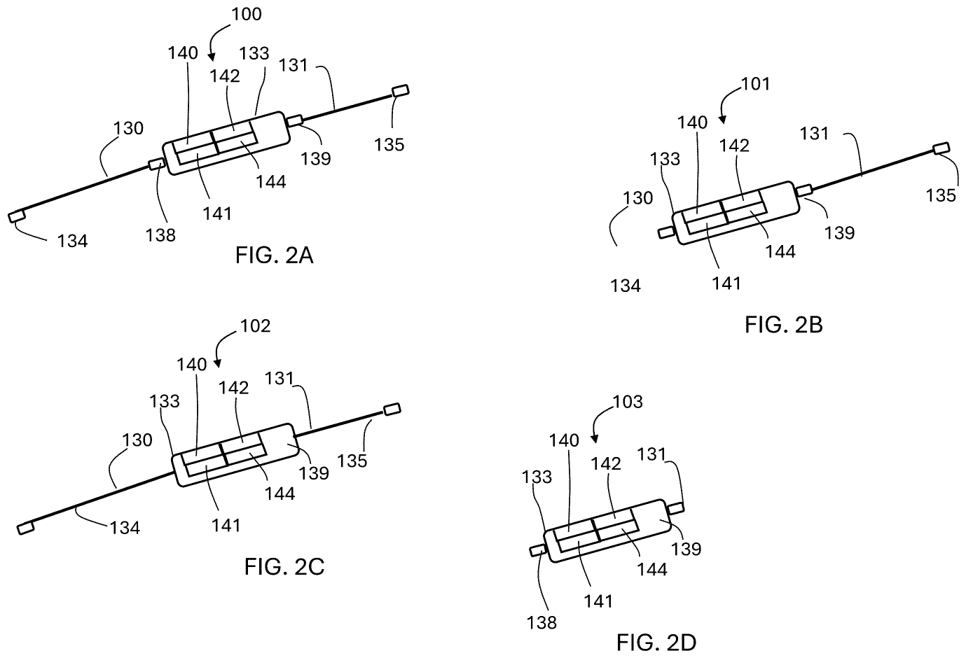

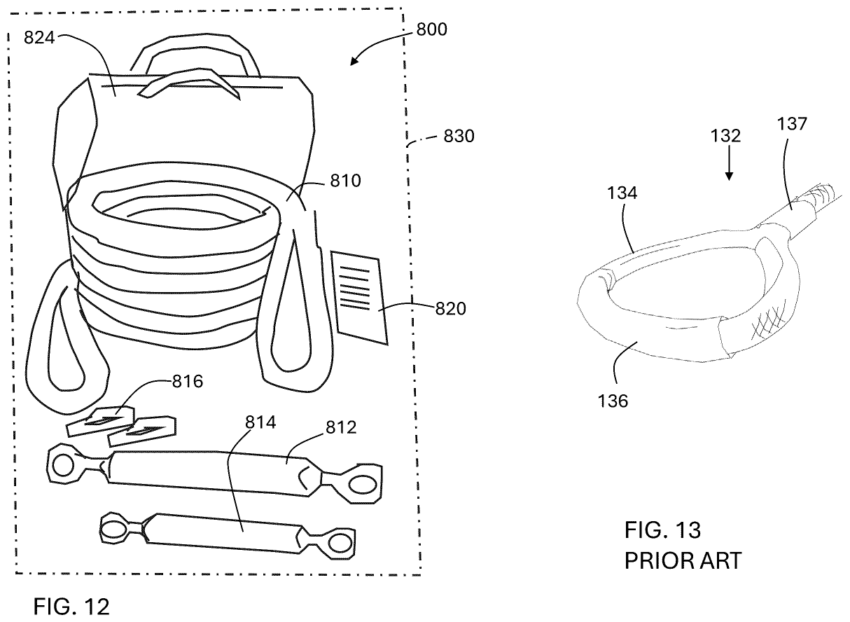

Referring to FIGS. 2A to 2D, conceptual views of embodiments of kinetic recovery systems 100, 101, 103, 105. FIG. 2A depicts kinetic recovery rope portion configured as a pair of kinetic rope segments 130, 131 with a kinetic fuse portion 133 positioned between the kinetic rope segments. Each kinetic rope segment 130, 131 having vehicle attachment connectors 134, 135, which can be, for example, woven and spliced in end loops 132 of braided synthetic rope, as illustrated in FIG. 13 such as nylon; the loops can have a sheathing 136 and a clamp or covering 137 on the spliced portion. Each kinetic rope segment 130, 131 connected to the fuse portion 133 by connections 138, 139. The fuse portion 133, can have integrated therewith, show schematically, a fusing element 140 or elements, with fusing element constraint structure 141, a visual indicator means 142 of the activation of the fuse portion, and kinetic recovery rope portion end retention means 144.

In FIG. 2B, the kinetic recovery system 101 has a single kinetic recovery rope segment 131 and the fuse portion has a vehicle attachment connector 134.

In FIG. 2C, the kinetic recovery system has the kinetic recovery rope segments 130, 131 extending into the fuse portion such as where the rope segments are utilized as the fuse portion fusing elements 140.

Referring to FIG. 2D, embodiments include a fuse portion sized suitably for UTV's, ATVs, side by side, or other off-road vehicles that can be attached to a single kinetic recovery rope or intermediate a pair of kinetic recovery ropes.

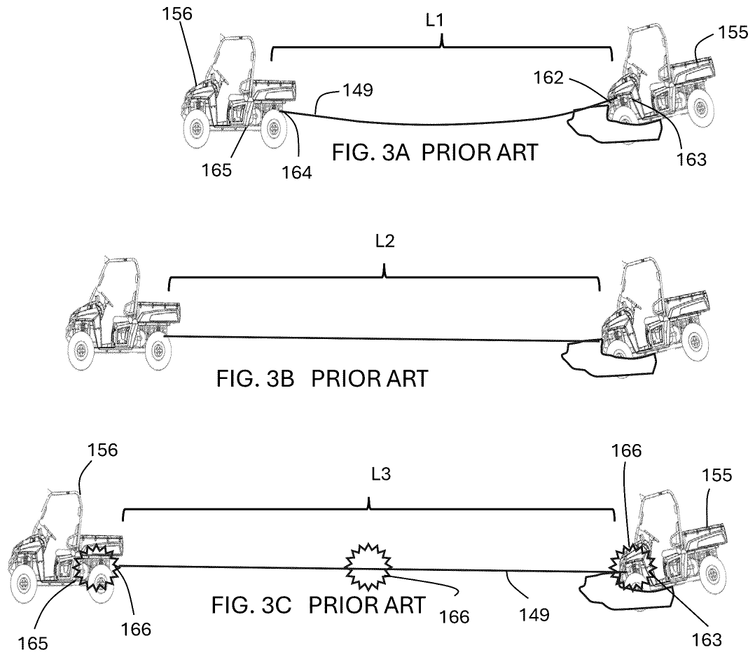

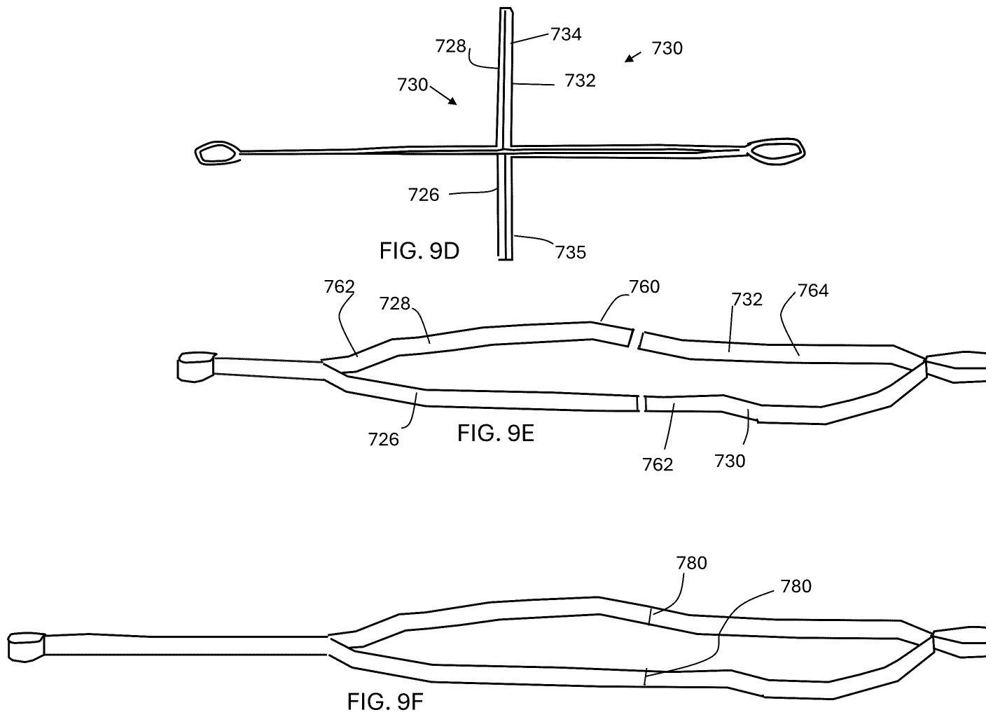

Referring to Prior Art FIGS. 3A to 3C, illustrate a conventional kinetic recovery rope 149 compared with a kinetic recovery system 150, illustrated in FIGS. 3D to 3G, with fusing with a stuck UTV 155 and a pulling or recovery UTV 156 are depicted. The conventional kinetic recovery rope 149 can be secured to a designated recovery connection point 162 on the frame 163 of the stuck UTV 155 and to the tow connection 164 on the frame 165 of the recovery UTV 156. FIG. 3A illustrates the kinetic recovery rope 149 in a slack position with an original unloaded length L1. In FIG. 3B the tow UTV has now moved forward a distance stretching the kinetic recovery rope 149 to a length L2 which equates to about 20% beyond the original length of the kinetic recovery rope. Note that kinetic recovery rope, particularly nylon braided kinetic recovery rope expands to about 20% (or less) of the resting length L1 under maximum rated working loading limits. For example, a 30 foot rope can expand by about 6 feet to a total stretched length of about 36 feet under maximum rated working loading. Referring to FIG. 3C, after continuing loading where the elongation approaches 30%, loading on the kinetic recovery rope 149, the stuck vehicle frame, the recovery vehicle frame 165 can exceed load limits and damage, indicated by the multi-pointed star circle 166 can occur to either or both off-road vehicles 155, 156 and/or the kinetic recovery rope 149, the kinetic recovery rope by breaking. Referring to the chart of FIG. 10, the loading of an exemplary kinetic recovery rope, for example formed of braided nylon, is illustrated by curve C1 and is plotted against its elongation. The breaking point, or tensile strength, of the kinetic recovery rope can be at about 30% elongation of its unloaded length, as illustrated by the 100% point on the y axis. Such ropes generally have a maximum rated loading of about 50% of the tensile strength which equates to about a 10% to 20% elongation over the original length.

Referring to FIG. 3D, the kinetic recovery system 150 with a fuse portion 151 having an initial inactivated length L4 and connected at an end 169 of a kinetic rope portion 170 having the original unloaded length L1. The other end 171 of the kinetic rope portion 170 mounted to a recovery connection point 162 of the stuck off-road vehicle 155. The other end 173 of the fuse portion 151 can be mounted to the tow connection 164 on the recovery vehicle 156. In FIG. 3E, the recovery vehicle 156 has advanced without moving the stuck vehicle 104, causing the kinetic rope portion 114 to expand to its rated maximum with the length L2 equating to about L1+20% L1. The fuse portion 151 being selected to have an activation load level at this rated maximum load level which activates the fuse portion 151 allowing the fuse portion 151 to elongate (e.g., an elongate fuse portion) to the full connected length L4 of the fuse portion 151 as depicted in FIG. 3F, before separation of the fuse elements 180, 181. The elongate fuse portion 151 selected or designed to allow the elongation of the fuse portion from its original length L4 to the full connected elongated length L5 to be at least enough to compensate for the elongation of the kinetic rope portion at its loading where the elongate fuse portion 151 activates. Referring to FIG. 3F, after the activation of the fuse portion 151, and with the maximum elongation of the fuse portion, two fuse elements 180, 181 can totally separate such that the kinetic recovery system 150 is now in two separate pieces. In embodiments, the two pieces can be connected or joined by a comparative low tensile strength supplemental retention line 185, shown in dotted lines, to keep the kinetic recovery system 150, with the now activated fuse portion 151, in a single piece. The tensile strength of the supplemental retention line 185 can be selected to easily break with minimal loading upon further movement of the recovery vehicle 156 away from the stuck off-road vehicle 155. For example, the tensile strength can be in a range from about 1 pound to 20 pounds. For example, the tensile strength can be less than about 30 lbs. Referring to the chart of FIG. 10, the loading of a kinetic recovery system of embodiments is illustrated by the curve C2. At about 50% of the tensile strength of the kinetic rope portion, the fuse portion can be activated at point P1, providing an extended elongation of the kinetic fuse portion, discussed below, when the activation load point of the fuse portion can be reached, as indicated by the horizontal line labeled C3. The curve C3 indicates in an embodiment where elongation continues at the load level of the activation of the fuse portion. Where the two fusing elements of the fusing portion separate after the elongation has maximized can be indicated by the point P4. Where the two end points are tethered the elongation, indicated by curve C5, can continue and the loading of the kinetic recovery system essentially goes to zero, see P5. Additional movement of the recovery vehicle with respect to the stuck vehicle can load the tether line, causing some further elongation, as shown by curve C6, and can then cause breakage of same at a low load level, see P7. The C4 curve indicates an embodiment of a fuse portion where the tensile loading to continue elongation of the fuse portion after fuse activation decreases. The C3 and C4 curves illustrate elongation E1 of the kinetic recovery system after fuse activation.

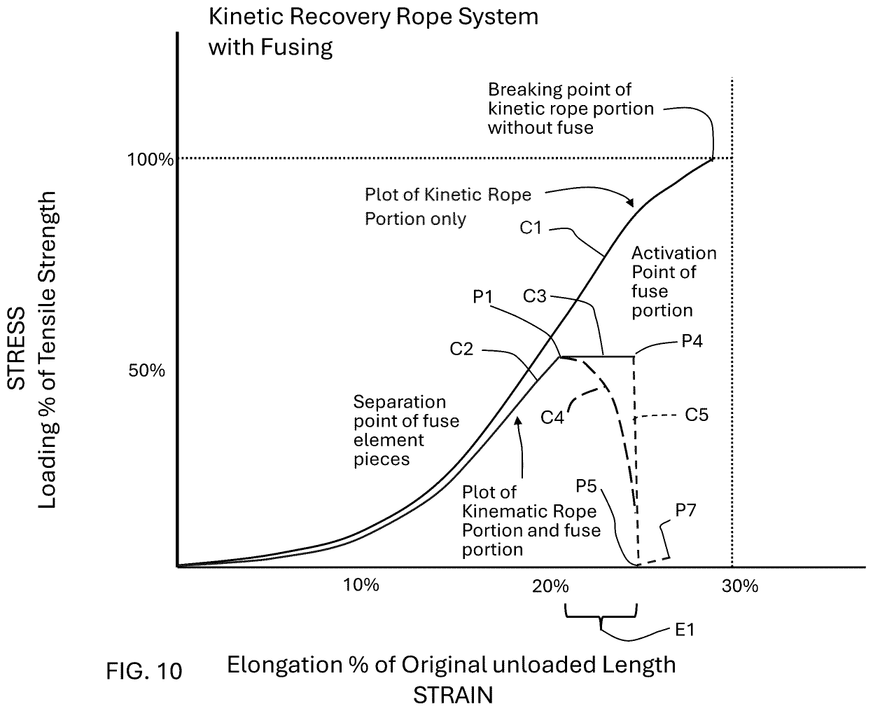

Referring to FIG. 11, an instance P10 where the fuse portion releases from the original fuse portion length to the full length essentially instantaneously can be indicated by curve C10, the loading goes to zero at point P12. Where the ends of the fuse portion elements are connected, the kinetic rope portion continues to elongate, see curve C12 until separation at point P14 which can be by a tether or other material or mechanism providing a relatively low tensile strength connection between the fuse portion element ends. For example, a difference between the fully activated connected length of the fuse portion and the inactivated length of the fuse portion is equal to or is greater than the elongation of the first kinetic rope portion at the activation load limit.

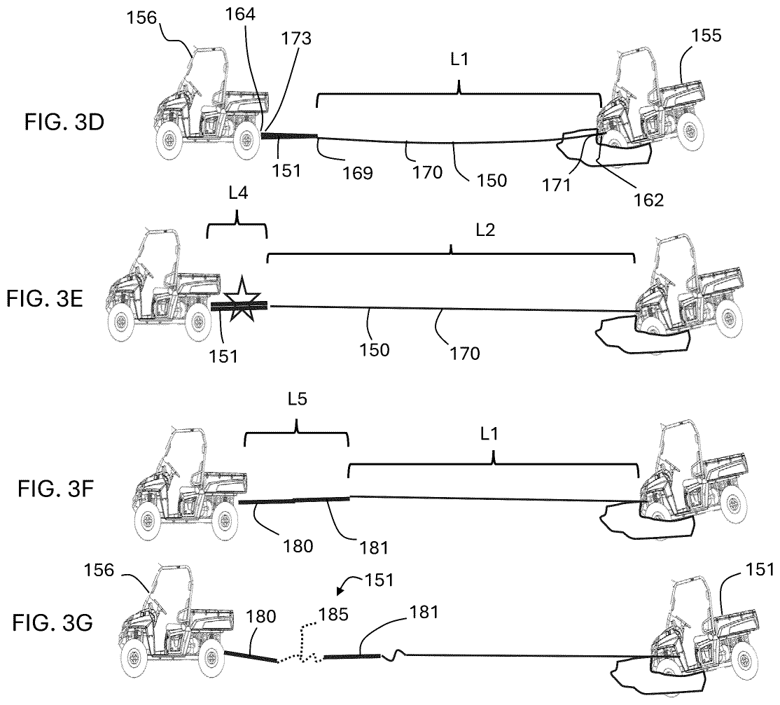

Referring to FIGS. 4A-9F, various configurations of embodiments of kinetic recovery systems and/or fuse portions are depicted.

Referring specifically to FIG. 4A to 4C, a fusing portion 300 has a pair of fuse elements 306, 308 that each have a connection 312, 314 at distal ends configured as loops. The fuse elements are arranged in an overlapping manner and secured together by fuse element constraint structure configured as clamps 320, 322, 324. In an example, the fuse activates the two pieces of the elongate fuse rope are inhibited from separating. In embodiments, the clamps can be configured as circular members, such as circular rings, and formed of rigid or elastomeric polymers or can be formed of various metals, or other materials. The clamps compressing and securing the overlapping fuse elements together in a securement 326. Where a sufficient tensile force can be applied to the ends of the fuse portion, the securement can be subjected to a shear force which at the activation load level causes shear slippage between the fuse elements 306, 308. As the inward ends 330, 332 of the fuse elements slide toward each other, they will transition and disengage from clamps 320 and 324, resulting in a lower tensile loading to continue separation. The slippage of the overlapping fuse elements 306, 308 within the clamps provides an extended activation delaying separation of the fusing elements, and providing a controlled elongation of the fuse portions, or fusing elements. For example, the fusing elements 306, 308 can slip through the clamp. In embodiments, a flag or other item can be associated with the activation of the fusing portion. Referring to FIGS. 4A and 4B, a flag 360 can be folded and otherwise contained within a clamp and attached to the fuse element such that pulling the fuse element out of the clamp unfurls the flag rending it visible to the operators of the stuck and recovery vehicles. The flag can have indicia thereon providing directions, warnings, or other information. The flag can be suitable colored to make it highly visible such as fluorescent coloration.

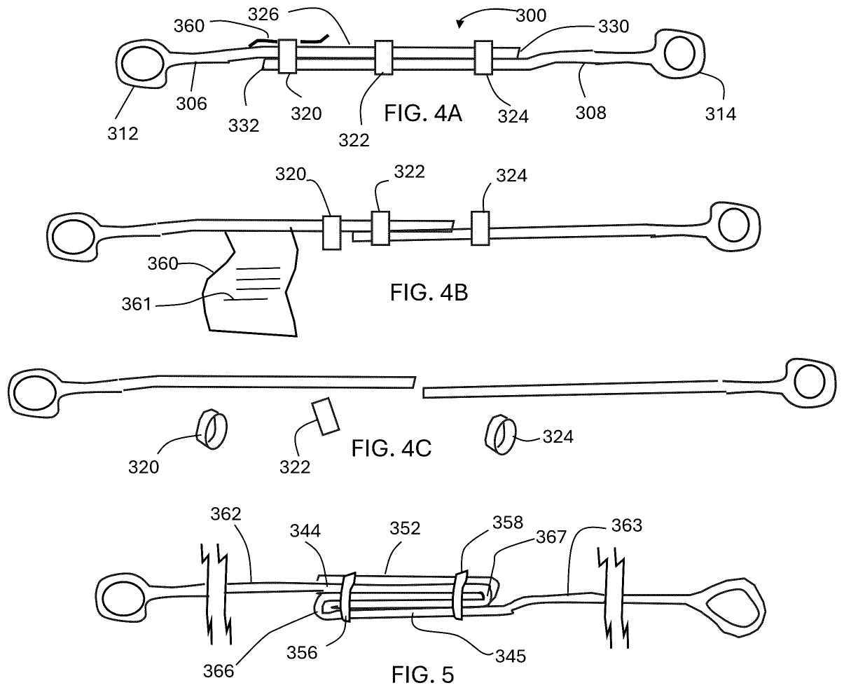

Referring to FIG. 5, in embodiments, the fuse elements 344, 345 can have multiple overlaps 346 that are secured together in a clamped securement by a plurality of clamps 356, 358. When the fuse element ends 362, 363 are under tensile loading to the fuse activation load level, the fuse commences elongation and the loops 366,367 approach the respective clamps 356, 358. Upon reaching and passing through the clamps, the loops are less restrained and the tensile loading on the kinetic recovery system decreases while elongation of the fuse portion continues.

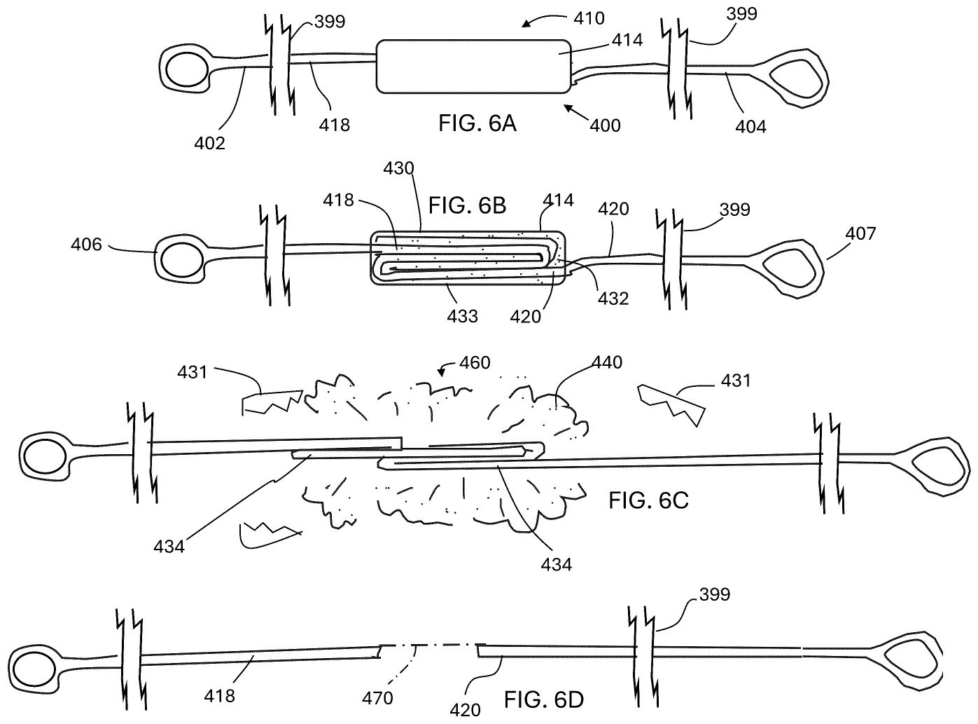

Referring specifically to FIGS. 6A to 6D, the line breaks 399 illustrate that the extending flexible members 402, 404 can be extended as part of a kinetic recovery system 400 with the extending flexible members 402, 404 constituting kinetic rope portions or the extending flexible members can be shortened to be part of just the fuse portion 410 to be used in conjunction with one or more other kinetic rope portions as part of a kinetic recovery system 411. As such, loops 406, 407 can be part of the fuse portion or part of the kinetic rope portion(s). FIG. 6A illustrates the fuse portion 410 that includes fusing element constraint structure configured as an enclosure 414 which encloses a pair of fuse elements 418, 420 that are arranged in a repeating overlapping bundle 426 as best illustrated by FIG. 6B with the enclosure cut away. The enclosure can also function as a clamp securing the bundle together in a securement 430. In embodiments, the enclosure can be formed by heat shrinkable tubing which provides an encapsulation and clamping of the bundle 426 of the fuse elements 418, 420. In embodiments, the bundle can be secured together within the enclosure by a matrix 432 formed of a polymer or an epoxy or other curable material that can be frangible. In embodiments the matrix 432 can be encapsulated or contained by an enclosure or the exposed exterior surface 433 can be the exposed matrix material. In embodiments, the overlapping fuse elements 418, 420 can be secured by potting material, or other material. The enclosure 414 can formed of a frangible polymer that can be fractured into multiple pieces 431 by tensile forces on the fuse elements 418, 420 which cause the peeling off of the overlapped layers 434 of the fuse element bundle 426 deforming the shape of the bundle and causing the breach of the enclosure, as best shown in FIG. 6C. In embodiments, enclosure can include a powder material 440 such that when the enclosure can be breached, such as shown in FIG. 6C, a powder smoke release 460 can be provided as a visual indicator of the fuse portion activation. In embodiments, disintegration of the matrix material upon fuse activation can release a cloud of particulates providing a visual indication of the fuse activation. FIG. 6D illustrates the fuse elements 418, 420 separated. In embodiments, the fusc elements can be connected by a retention member 470 such as low tensile strength tether line. Similar to the embodiments of FIGS. 4A and 4B, a flag 361 can be attached to a fuse element and contained within the enclosure to release when the fuse portion can be activated.

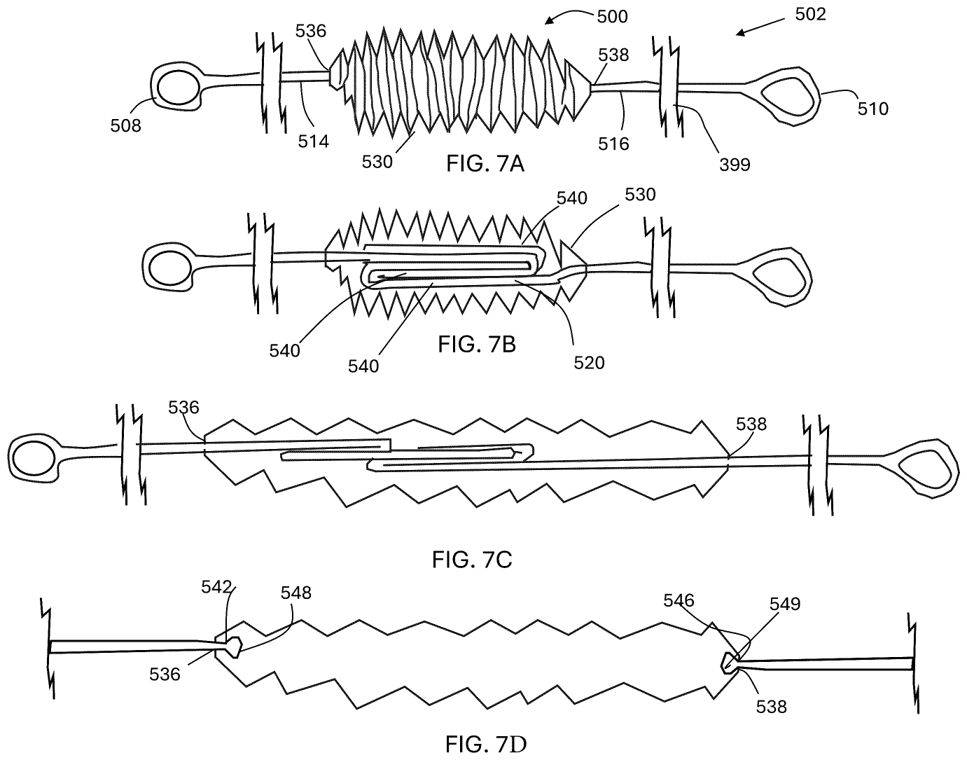

Referring to FIGS. 7A to 7D, another fuse portion 500 and/or kinetic recovery system 502 can be illustrated with the loops 508, 510 being alternatively part of the fuse portion 500 or displaced from the fuse portion on ends of the kinetic rope portions. The fuse elements 514, 516 are overlapping in a bundle 520 that can be contained in an expandable enclosure 530 formed of a sheet material such as a fabric, for example canvas, or a polymeric sheet material. The fuse elements extending out of end openings 536, 538 in the expandable enclosure 530. The expandable enclosure 530 can be configured as a bellows. The bundle secured together in embodiments by adhesive such that under sufficient tensile force on the fuse element extending from the enclosure, the tensile force equaling the activation level of the fusing portion, the layers 540 of the bundle 520 peel away providing an extended activation period which provides an elongation of the fuse portion 500 and the expandable enclosure 530. In embodiments, the overlapping bundle can be secured with clamps such as is illustrated with reference to FIGS. 4A-5. In embodiments, the ends 542, 546 of the fuse elements can have stoppers 548, 549 that are oversized to enclosure end openings 536, 538 such that the enclosure can be retained with the fuse elements 514, 516 upon activation and activation elongation. With continued movement of the recovery vehicle away from the stuck vehicle after maximum elongation of the fuse portion can be reached, one of the fuse elements 514, 516 can separate from the expandable enclosure 530 such as by ripping or other destruction of the enclosure 530.

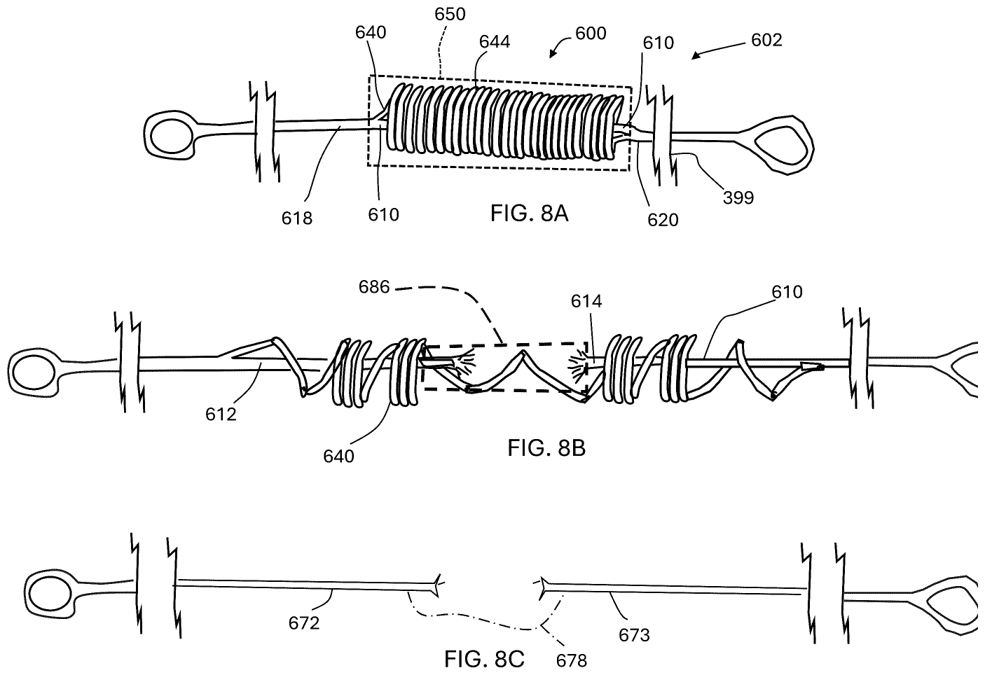

Referring to FIGS. 8A to 8C, an embodiment of a fuse portion 600 or kinetic recovery system 602 is depicted where the fuse portion 600 has a single main fuse element 610 that breaks at the activation load level of the fuse portion into two main fuse element pieces 612, 614. Connected to two fuse input leads 618, 620 can be a supplemental coiled activation extender line or secondary fuse element 640. The coil 644 and main fuse element 610 can be secured within an enclosure 650 as indicated or can be secured together with an adhesive or polymeric matrix, or an epoxy, or with a potting material. The unraveling of the secondary fuse element coil can be effectuated at a significantly less load level that the breaking of the main fuse element. A feature and advantage can be that the secondary coiled fusing element provides retention of the main fuse element pieces. The supplemental coiled activation extender line extends the activation time of the fuse. The secondary fuse element can break at a significantly lower load level the main fuse element into two secondary fuse element pieces 672, 673 or can have a tether 678 or connecting piece that releases or breaks at a low tensile level. After full extension, the secondary fuse can in embodiments be coiled directly on the main fuse element. In embodiments, the secondary fuse can be laid in an overlapping manner on the main fuse element similar to the embodiments of FIGS. 6A to 7D. In embodiments, the secondary fuse overlapping layers can be clamped to the main fuse element, or contained for example, in heat shrinkable tubing. In embodiments, the length of the secondary fuse element will be at least long enough to compensate for the elongation of the kinetic rope portion connected to the fuse portion at the activation load level of the main fuse element of the fuse portion. Referring in particular to FIG. 8B, in embodiments, the coil windings can be wrapped directly on the main fuse element or elements 610 or can be wound to provide a gap between the coil and main fuse element or elements. A visual indicator means 686 of fuse activation can be provided such as in the gap. In embodiments, the visual indicator means can be a flag to be released or a powder package, for example.

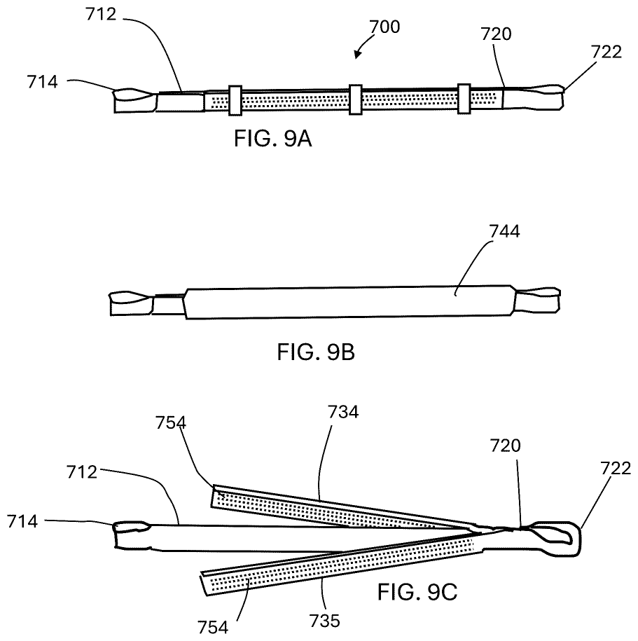

Referring to FIGS. 9A to 9F, a fuse portion 700 of a kinetic recovery system is shown. The fuse portion can include a main base strap portion 712 connected to first loop 714 and opposite a secondary strap portion 720 with a second loop 722. A fusing portion 730 positioned intermediate the main base strap portion and secondary strap portion. The fusing portion 730 comprising two fuse strap elements 726, 728 connecting to the main base strap and two cooperating interfaced fuse strap elements 726, 728 connected to the secondary strap portion. Fuse strap element 726 can be stitched to fusing portion 730 and fuse strap element 728 can be stitched to fusing portion 732. The cooperating strap elements sewn together defining a pair of separatable fusing wings 734, 735 as illustrated in the configuration of FIG. 9C. The pair of separatable fusing wings 734, 735 can be secured together with the main base strap portion with a sleeve, casing, or enclosure 744 as illustrated in FIG. 9B. In embodiments, the two fuse strap elements 726, 728 can be held together by stitching 754. The sleeve, casing, or enclosure 744 can be, for example, fabric, a polymer coating, a stretchable material, an elastomeric material, or other sheet material. FIG. 9D depicts an activated fuse portion 700 with the stitched together fuse elements partially separated at the separated portions 760, 762. The stitching providing an extended release consistent with curve C3 of FIG. 10. FIG. 9E depicts a complete release and separation of the fuse strap elements 726, 728, including fusing portions 730, 732 after activation. FIG. 9F depicts an embodiment where the two fuse strap elements are connected after the complete release but separation has not yet occurred. A weakened portion intermediate two fuse strap portions can provide a further release point 780 at a greatly lowered tensile strength. In embodiments, visual indicator means of fuse activation can be provided beyond the separation of the cooperating strap elements. For example, coloration, such as fluorescent coloration can be provided on the interior surfaces of the separation portions 762, 764 of the strap elements.

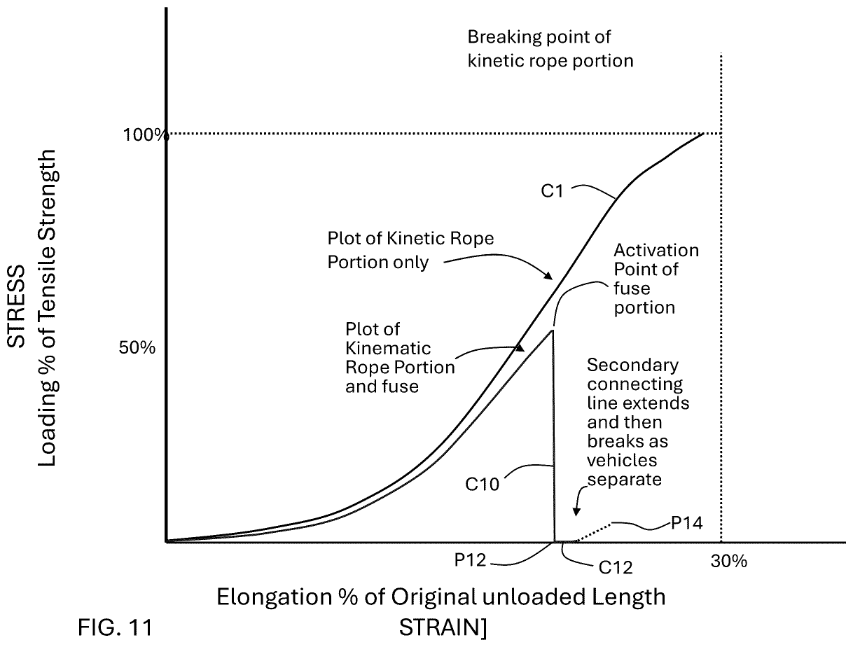

Referring to FIG. 12, a kinetic recovery system kit 800 can be packaged as a retail assemblage 802 comprising a kinetic recovery rope 810, a pair of kinetic fuse portions 812, 814, a plurality of soft shackles 816, instructions for use 820, a stowage bag 824 and packaging 830. In some embodiments, the kinetic recovery system kit 800 can be provided with instructions for use. The instructions are provided on a tangible, non-transitory medium, and can be physically included with the kit 800 such as on a printed document, compact disc, or flash drive. Non-limiting examples of a tangible, non-transitory medium include a paper document and computer-readable media including compact disc and magnetic storage devices (e.g., hard disk, flash drive, cartridge, floppy drive). The computer-readable media can be local or accessible over the internet. The instructions can be complete on a single medium or divided among two or more media. For example, some of the instructions can be written on a paper document that instruct the user to access one or more of the steps of the method over the internet, the internet-accessible steps being stored on a computer-readable medium or media. The instructions can embody the techniques and methods of protecting the off-road vehicles depicted or described herein using text, photos, videos, or a combination thereof to instruct and guide the user. The instructions can be in the form of written words, figures, photos, video presentations, or a combination thereof to instruct and guide the user.

Alternative fuses that expand allow the rope portions to release stored energy without recoiling or fully separating are not beyond the scope of this disclosure. In some embodiments, the kinetic tow rope could have a fusing section configured to release and lengthen at a predetermined threshold allowing the rope to release stored energy prior to breakage.

Each of the additional figures and methods disclosed herein can be used separately, or in conjunction with other features and methods, to provide improved devices and methods for making and using the same. Therefore, combinations of features and methods disclosed herein cannot be necessary to practice the disclosure in its broadest sense and are instead disclosed merely to particularly describe representative and preferred embodiments.

Various modifications to the embodiments can be apparent to one of skill in the art upon reading this disclosure. For example, persons of ordinary skill in the relevant arts will recognize that the various features described for the different embodiments can be suitably combined, uncombined, and re-combined with other features, alone, or in different combinations. Likewise, the various features described above should all be regarded as example embodiments, rather than limitations to the scope or spirit of the disclosure.

While the disclosure has been described in connection with what is presently considered to be the most practical and preferred embodiments, it is to be understood that the disclosure is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore, it should be understood that while the use of the word preferable, preferably, or preferred in the description above indicates that feature so described can be more desirable, it nonetheless cannot be necessary and any embodiment lacking the same can be contemplated as within the scope of the disclosure, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the element can be a less than all portion of an item, component, or assembly, and/or can be the entire item, component, or assembly, unless specifically stated to the contrary.

What is claimed is:

1. A kinetic recovery system for recovery of a stuck off-road vehicle, the kinetic recovery system connectable to the stuck off-road vehicle and to a recovery vehicle, the kinetic recovery system comprising:
a first kinetic rope portion having a working loading with an elongation of from 10% to 20% of an unloaded kinetic rope portion, the first kinetic rope portion having a breaking load limit at an elongation in a range of about 25% to about 35%; and
a fuse portion having an inactivated length and a fully activated connected length, the fuse portion having an activation load limit less than the breaking load limit of the first kinetic rope portion.

2. The kinetic recovery system of claim 1, wherein a difference between the fully activated connected length of the fuse portion and the inactivated length of the fuse portion is equal to or is greater than the elongation of the first kinetic rope portion at the activation load limit.

3. The kinetic recovery system of claim 1, wherein the fuse portion has an elongate fuse rope or strap formed into an arrangement that is arranged in an overlapping or bundled arrangement, with the arrangement secured together.

4. The kinetic recovery system of claim 3, wherein the arrangement is secured together with one or more of: one or more clamps, adhesives, potting material, sleeving, tubing, heat shrinkable tubing, stitching, and wrapped or coiled rope.

5. The kinetic recovery system of claim 3 wherein the elongate fuse rope or the strap comprises two pieces.

6. The kinetic recovery system of claim 5, wherein the fuse portion is configured to activate the two pieces of the elongate fuse rope, and the two pieces are inhibited from separating.

7. The kinetic recovery system of claim 5, wherein the two pieces of the elongate fuse rope or a strap are tethered together at their respective ends.

8. The kinetic recovery system of claim 5, wherein the elongate fuse rope or the strap comprises a fuse rope and the fuse rope is formed of a similar material as the first kinetic rope portion.

9. The kinetic recovery system of claim 1, wherein when the fuse portion is activated the fuse portion transitions directly to a full activated length.

10. The kinetic recovery system of claim 1, wherein when the fuse portion is activated, the fuse portion transitions to an intermediate length that is less than a full activated length.

11. The kinetic recovery system of claim 1, wherein when the fuse portion is activated, the fuse portion transitions to an intermediate length that is less than a full activated length.

12. The kinetic recovery system of claim 1, wherein there is an extended activation that allows a controlled elongation of the fuse portion after activation of the fuse portion.

13. The kinetic recovery system of claim 12, wherein the extended activation is provided by at least one of:
a pair of fuse elements sliding in shear;
a fuse element unraveling from a coil;
a fuse element peeling off of a layered fuse element bundle;
a pair of cooperating fuse elements separating by breaking of stitching;
a fuse element being pulled from a bundle of the fuse element; and
a fuse element slipping through a clamp.

14. The kinetic recovery system of claim 1, wherein at least one end of the kinetic recovery system is configured as loops.

15. The kinetic recovery system of claim 1, wherein the fuse portion comprises a visual indicator when the fuse portion is activated.

16. The kinetic recovery system of claim 15, wherein the visual indicator is a flag that is unfurled when the fuse portion is activated.

17. The kinetic recovery system of claim 15, wherein the visual indicator is a powder that is released when the fuse portion is activated.

18. The kinetic recovery system of claim 1, wherein the fuse portion further comprises an extendable enclosure with fuse element openings sized to retain ends of fusing elements within the extendable enclosure.

19. The kinetic recovery system of claim 1, further comprising a second kinetic rope portion of a similar configuration as the first kinetic rope portion.

20. The kinetic recovery system of claim 1, wherein the first kinetic rope portion is formed of braided nylon and has a diameter of ½ inch or less.

21. A fuse portion for attachment to a kinetic recovery rope, the fuse portion comprising:
elongate fuse elements arranged in an overlapping or bundled arrangement, wherein the elongate fuse elements are secured together by a clamp, adhesive, potting, or an enclosure.

22. The fuse portion of claim 21, wherein the fuse portion has two elongate fuse elements arranged in an overlapping arrangement.

23. The fuse portion of claim 22, wherein the elongate fuse elements are separate pieces joined by the clamp, adhesive, potting, or the enclosure.

24. The fuse portion of claim 22, wherein the elongate fuse elements are separate pieces with their ends tethered together.

25. The fuse portion of claim 22, wherein when the fuse portion activates, the elongate fuse elements are inhibited from separating.

26. The fuse portion of claim 21, wherein the fuse portion has an inactivated length and an activated connected length, and the activated connected length is at least twice the inactivated length.

27. The fuse portion of claim 21, wherein when the fuse portion is activated, the fuse portion transitions to intermediate length that is less than a full activated length.

28. The fuse portion of claim 21, wherein the fuse portion has an extended activation that allows a controlled elongation of the fuse portion after activation of the fuse portion.

29. The fuse portion of claim 28, wherein the extended activation is provided by at least one of:
a pair of fuse elements sliding in shear;
a fuse element unraveling from a coil;
a fuse element peeling off of a layered fuse element bundle;
a pair of cooperating fuse elements separating by breaking of stitching;
a fuse element being pulled from a bundle of the fuse element; and
a fuse element slipping through a clamp.

30. The fuse portion of claim 21, wherein the fuse portion comprises a visual indicator when the fuse portion is activated.

31. The fuse portion of claim 30, wherein the visual indicator is a flag that is unfurled when the fuse portion is activated.

32. The fuse portion of claim 30, wherein the visual indicator is a powder that is released when the fuse portion is activated.

33. The fuse portion of claim 21, wherein the fuse portion further comprises an extendable enclosure.

34. The fuse portion of claim 33, wherein the extendable enclosure has fuse element openings sized to retain ends of fusing elements within the extendable enclosure after activation.

35. A method of protecting off-road vehicles involved in a recovery operation where a first off-road vehicle is in a stuck position and a second off-road vehicle is utilized to pull the first off-road vehicle out of the stuck position with a kinetic recovery rope, the method comprising:
assessing a first off-road vehicle frame load limits at recovery attachment points of the first off-road vehicle and the second off-road vehicle; and
selecting a fuse portion of the kinetic recovery rope, the fuse portion having an activation load limit below the vehicle frame load limits at the recovery attachment points.

36. The method of claim 35, further comprising selecting a fuse portion at least 30% lower than at least one of the first off-road vehicle or the second off-road vehicle frame load limits at the recovery attachment points.

37. The method of claim 35, further comprising assessing the first off-road vehicle frame load limit at the recovery attachment point at less than 3 times a weight of the first off-road when the first off-road vehicle is in an unloaded configuration.

38. The method of claim 35, further comprising sizing selecting a kinetic rope portion with a tensile strength of at least three times a weight of at least one of the first off-road vehicle or the second off-road vehicle.

39. A kinetic recovery system comprising a kinetic rope portion formed of braided nylon recovery rope portion connected to a fuse portion, wherein the fuse portion under tensile loading have a pair of overlapping fuse elements subjected to shear loading, and wherein the fuse portion has an activation load level that correlates to when the overlapping fuse elements slip in shear with respect to one another.

40. The kinetic recovery system of claim 39, wherein the overlapping fuse elements are clamped together.

41. The kinetic recovery system of claim 39, wherein the overlapping fuse elements are clamped with a plurality of circular rings.

42. The kinetic recovery system of claim 39, wherein the kinetic recovery system is metal free.

43. The kinetic recovery system of claim 39, configured as a retail assemblage and further comprising a stowage bag and instructions for use.
